(19) United States
(12) Patent Application Publication
(10) Pub. No.: US 2015/0322913 A1
(43) Pub. Date: Nov. 12, 2015

(54) PLASMA GENERATING APPARATUS AND INTERNAL COMBUSTION ENGINE

(71) Applicant: IMAGINEERING, INC., Kobe (JP)

(72) Inventor: Yuji IKEDA, Kobe (JP)

(21) Appl. No.: 14/806,045

(22) Filed: Jul. 22, 2015

Related U.S. Application Data
(63) Continuation of application No. PCT/JP2014/051068, filed on Jan. 21, 2014.

(30) Foreign Application Priority Data
Jan. 22, 2013 (JP) 2013-0009175

(51) Int. Cl. F02P 23/04

(52) U.S. Cl. CPC F02P 23/045

(57) ABSTRACT

The plasma generating device has an electromagnetic wave oscillator that emits electromagnetic waves, and a control device that controls the electromagnetic wave oscillator, said plasma generating device being characterized by being provided with a step-up circuit that causes the electromagnetic waves that have been emitted from the electromagnetic wave oscillator to resonate, thereby generating a high voltage, and a discharge electrode that discharges the high voltage generated by the step-up circuit.

### TECHNICAL FIELD

The present invention relates to a plasma generating apparatus and an internal combustion engine employing thereof.

### BACKGROUND

There is known a plasma generating apparatus that emits an electromagnetic wave to a target space and generates electromagnetic wave plasma. For example, JP 2009-38025 A1 and JP 2006-132518 A1 disclose this kind of plasma generating apparatus.

JP 2009-38025 A1 discloses a plasma generating apparatus that causes spark discharge in a discharge gap of a spark plug and that enlarges plasma by emitting microwave to the discharge gap. The plasma which is generated by the spark discharge receives energy from microwave pulse in this plasma generating apparatus. The electron in plasma domain is thereby accelerated and the ionization is promoted to increase the volume of plasma.

JP 2009-38025 A1 discloses an ignition device of an internal combustion engine that generates plasma discharge by emitting electromagnetic wave to a combustion chamber from an electromagnetic wave emitting device. An ignition electrode that is insulated from the piston is provided on the upper surface of the piston. The ignition electrode increases, in the neighborhood, the local electric field of the electromagnetic waves in the combustion chamber.

However, the plasma generating apparatus of JP 2009-38025 A1 requires at least two power supplies, that is, a high voltage power supply for generating discharge in a spark plug, and a high frequency power supply for emitting microwave. This kind of plasma generating apparatus, which requires multiple power supplies, have a disadvantage in securing an installation space because the allocation space for installation is limited when this plasma generating apparatus is utilized for combustion chamber of an automobile engine. The transmission system of this kind of plasma generating apparatus requires both a high voltage transmission system for conventional spark plug and an electromagnetic wave transmission system. Therefore, the system becomes highly complicated. The plasma generating apparatus described in the JP 2006-132518 A1 needs only a single power supply because the plasma is generated solely by electromagnetic waves; however, a huge amount of power shall be supplied from the high frequency power supply in order to ignite and generate combustion reaction solely by electromagnetic wave.

### SUMMARY

The present invention relates to a plasma generating apparatus including an electromagnetic wave oscillator that oscillates electromagnetic wave and a control device that controls the electromagnetic wave oscillator, comprising: an amplifying circuit that cause resonation of an electromagnetic wave oscillated by an electromagnetic wave oscillator and generates high voltage; and a discharge electrode that discharges high voltage generated by the amplifying circuit.

### BRIEF DESCRIPTION OF THE DRAWINGS

FIG. 1 is a block diagram of a plasma generating apparatus of the first embodiment.

FIG. 2 is a vertical sectional view of an internal combustion engine of the first embodiment.

FIG. 3 is a vertical sectional view of the plasma generating apparatus of the first embodiment.

FIG. 4 is an equivalent circuit of the plasma generating apparatus of the first embodiment.

FIG. 5 is an example of oscillating pattern of electromagnetic wave of a plasma generating apparatus of the first embodiment.

FIG. 6 is an example of oscillating pattern of electromagnetic wave of a plasma generating apparatus of the modification 1 of the first embodiment.

FIG. 7 is another vertical sectional view of the plasma generating apparatus of the first embodiment.

FIG. 8 is another equivalent circuit of the plasma generating apparatus of the first embodiment.

### DETAILED DESCRIPTION

In the following, a detailed description will be given by an embodiment of the present invention with reference to the accompanying drawings. It should be noted that the following embodiments are merely preferable examples, and do not limit the scope of the present invention, applied field thereof, or application thereof.

### First Embodiment

### Plasma Generating Apparatus

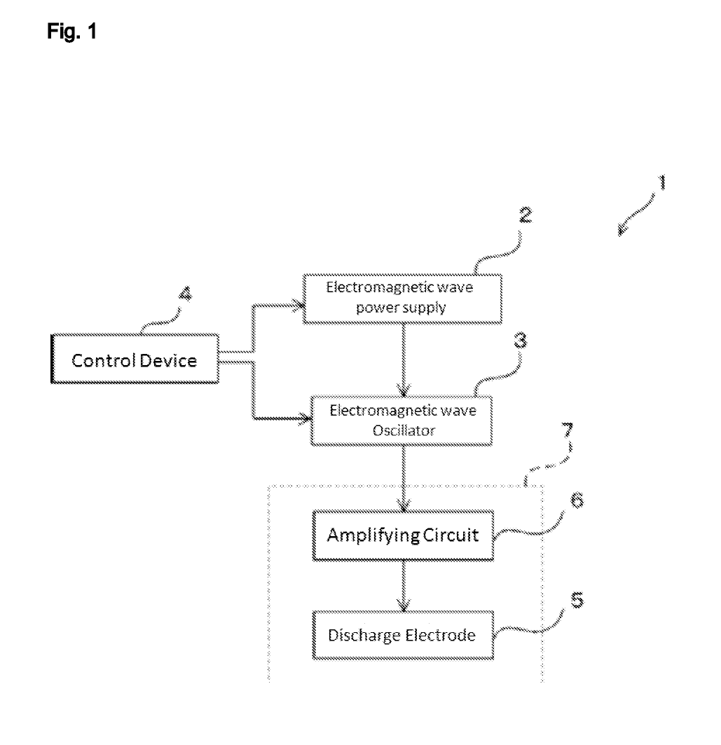

The first embodiment relates to a plasma generating apparatus of the present invention. The plasma generating apparatus equips electromagnetic wave power supply 2 (power supply for electromagnetic wave), electromagnetic wave oscillator 3, amplifying circuit 6, discharge electrode 5, and control device 4 as shown in FIG. 1.

Electromagnetic wave power supply 2 outputs a pulsed current to electromagnetic wave oscillator 3 of a pattern that is preset with a predetermined duty ratio and pulse time, when an electromagnetic wave oscillation signal, e.g. TTL signal, is received from control device 4.

Electromagnetic wave oscillator 3 is a semiconductor oscillator, for example. Electromagnetic wave oscillator 3 is connected electrically to electromagnetic wave power supply 2. Electromagnetic wave oscillator 3 outputs microwave pulse to amplifying circuit 6, when a pulsed current is received from electromagnetic wave power supply 2.

Amplifying circuit 6 has input unit center electrode 53 (center electrode of an input unit), output unit center electrode 56 (center electrode of an output unit), connecting part electrode 54 (electrode of a connecting part), grounding coil 55, and insulator 59 as shown in FIG. 3. The center electrode 53 is installed inside microwave plasma plug 50 via input unit 52 from electromagnetic wave oscillator 3, and is capacity coupled via connecting part electrode 54 and insulator 59. One end of output unit center electrode 56 is connected directly to connecting part electrode 54. Other end of output unit center electrode 56 is discharge electrode 5. Output unit center electrode 56 is covered with insulator 59 except for discharge electrode 5 portion and a coil structure of grounding coil 55 is formed in the circumference. One end of grounding coil 55 is connected to connecting part electrode 54, and the other end is grounded near discharge electrode. Amplifying circuit 6 is structured such that a floating capacity between grounding coil 55 and outside case 51 and a floating capacity between connecting part electrode 54 and outside case 51 cause the resonation to generate the high voltage. The coil structure part of grounding coil 55 is embedded inside insulator 59. The generated high voltage is discharged from discharge electrode 5 toward a neighboring earth electrode 57. Amplifying circuit 6 is installed inside microwave plasma plug 50, as shown in FIG. 3.

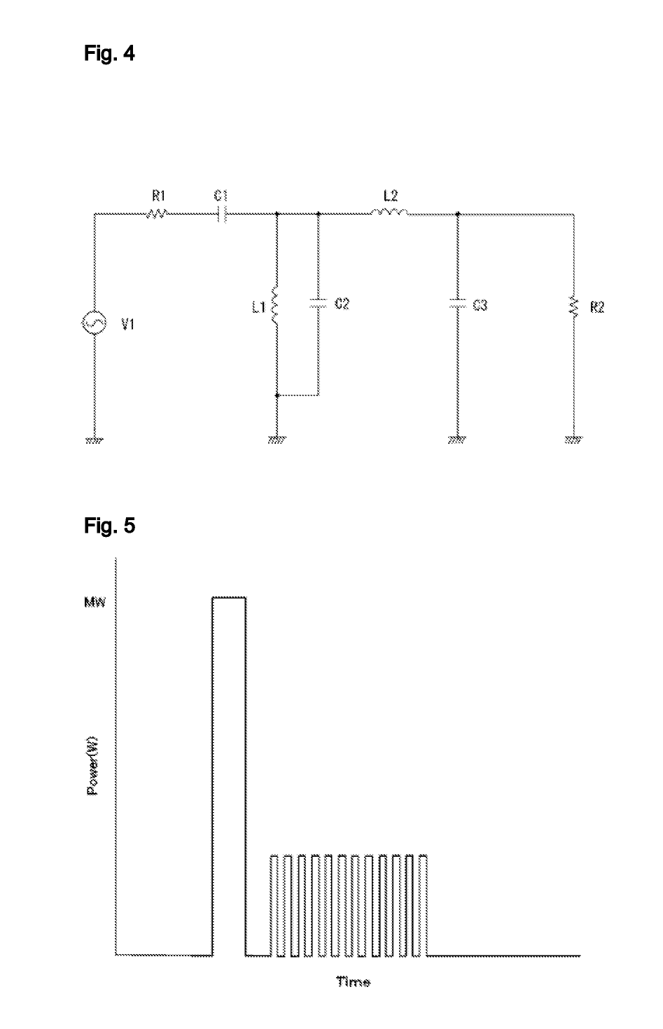

FIG. 4 describes an equivalent circuit of amplifying circuit 6. Amplifying circuit 6 includes a parallel resonance circuit, capacity coupled to electromagnetic wave oscillator 3, consisting coil L1 and capacitor C2. Further, amplifying circuit 6 also includes a resonant circuit that is capacity coupled to electromagnetic wave oscillator 3 and consisting coil L2 and capacitor C3. The frequency ratio of the parallel resonance circuit to the resonant circuit is preferably in the range of 0.80 to 1.20. More preferably, the range shall be 0.90 to 1.10. Further more preferably, the range shall be 0.95 to 1.05. Further most preferably, the ratio shall be 1.00.

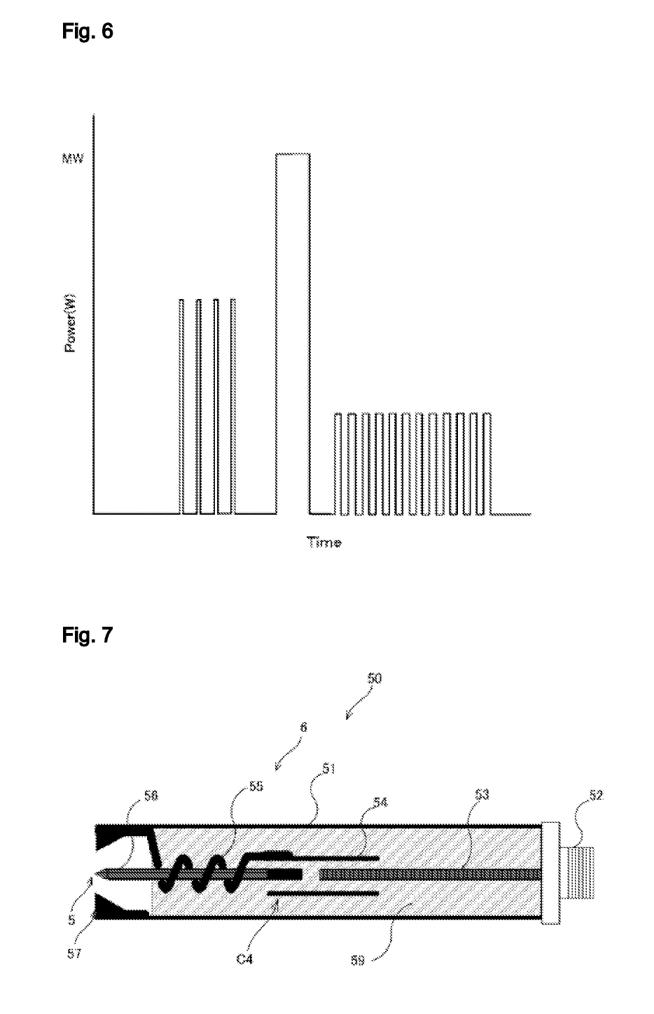

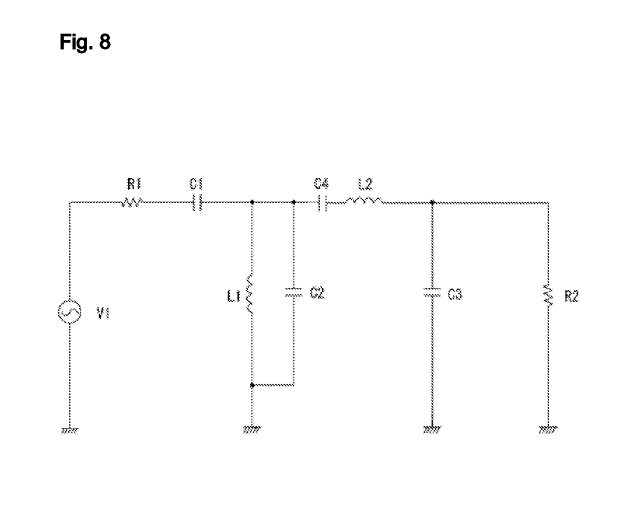

A series resonance circuit can be provided in discharge electrode 58 side of parallel resonance circuit. FIG. 6 describes amplifying circuit 60 of the present case and FIG. 7 describes an equivalent circuit of amplifying circuit 60. This amplifying circuit 60 has a series resonance circuit consisting coil L2 and capacitor C4 in discharge electrode 58 side of the parallel resonance circuit consisting of coil L1 and capacitor C2. As shown in FIG. 6, the end of discharge electrode 58 serving as coil L2 is separated from connecting part electrode 54. The tip part of discharge electrode 58 and the electrode 54 constitutes capacitor C4. The employment of series resonance circuit maintains a matching with electromagnetic wave oscillator even in low resistance because the plasma is generated from discharge electrode, and reduces the reflection of electromagnetic wave. In this case, preferably, the resonance frequencies of the parallel resonance circuit and the series resonance circuit are substantially the same.

—Operation of the Plasma Generating Apparatus—

The plasma generating operation of plasma generating apparatus 1 is discussed. In the plasma generating operation, plasma arises near discharge electrode 5 by a discharge from discharge electrode 5.

In detail, control device 4 first outputs electromagnetic wave oscillation signal of condition that occur spark discharge in the plasma generating operation. Electromagnetic wave power supply 2 outputs a pulse current of predetermined duty ratio for a predetermined set period when such an electromagnetic wave oscillation signal is received from control device 4. Electromagnetic wave oscillator 3 outputs an electromagnetic wave pulse of predetermined duty ratio for the set period. The electromagnetic wave pulse outputted from electromagnetic wave oscillator 3 becomes the high voltage using amplifying circuit 6 due to the resonance of a floating capacity between grounding coil 55 and outside case 51 and a floating capacity between connecting part electrode 54 and outside case 51. Then the discharge occurs from discharge electrode 5 to earth electrode 57 and generates a spark. This spark allows an emission of electron from gas molecule near discharge electrode 5 and plasma is thereby generated.

Control device 4 then outputs the electromagnetic wave oscillation signal of conditions that maintains and enlarges the plasma. Electromagnetic wave power supply 2 outputs the pulse current of a predetermined duty ratio for a predetermined set period when such an electromagnetic wave oscillation signal is received from control device 4. Electromagnetic wave oscillator 3 outputs an electromagnetic wave pulse of a predetermined duty ratio for the set period. Microwave (for assisting) outputted from electromagnetic wave oscillator 3 is discharged from discharge electrode 5 via amplifying circuit 6. This allows a maintenance and enlargement of the plasma generated by spark discharge.

FIG. 5 describes an example of predetermined oscillation pattern which includes an electromagnetic wave pulse of conditions that causes spark discharge and an electromagnetic wave pulse of conditions that maintains and enlarges the generated plasma in plasma generating apparatus 1 of this embodiment. It is necessary to emit the microwave of a certain amount or more to causes spark discharge in discharge electrode 5 and to generate plasma. The microwave can be a single pulse or multiple pulses having a predetermined duty ratio and a predetermined set period as necessity. Then the plasma can be maintained or enlarged by oscillating microwave of a predetermined duty ratio for a predetermined set period. The electric power required for maintaining and enlarging the plasma can thereby be smaller than the electricity needed for occurring spark discharge.

The voltage becomes small when the plasma is generated by the occurrence of the spark discharge as mentioned above, because the generated plasma functions as resistance. Therefore, the plasma can be maintained or enlarged even when the oscillation of electromagnetic wave pulse of condition that occur spark discharge is continued because the voltage is controlled to be low automatically after the plasma is generated by the spark.

When a predetermined set period has elapsed from the rising edge of the electromagnetic wave oscillation signal, the oscillation of the microwave pulse is suspended and the microwave plasma disappears.

### Advantage of the First Embodiment

Plasma generating apparatus 1 of the first embodiment can generate high voltage by containing amplifying circuit 6 that cause resonation of electromagnetic wave and can cause spark solely by electromagnetic wave. Therefore, the plasma can be generated, maintained, or enlarged solely by electromagnetic waves. Electromagnetic wave power supply 2 is sufficient for the power supply and the complicated transmission lines are not necessary. Further, a predetermined oscillation pattern containing an electromagnetic wave pulse of condition that causes spark discharge and an electromagnetic wave pulse of condition that enlarges and maintains the generated plasma is used. This allows an efficient generation, enlargement, and maintenance of the plasma solely by the electromagnetic wave and can reduce the total power consumption. The diameter of a microwave plasma plug can be made thinner because output unit center electrode 56 passes inside of the coil structure portion of grounding coil 55.

### Modification 1 of the First Embodiment 1

In the modification 1 of the first embodiment, a part of the plasma generation operations differs from the first embodiment. As shown in FIG. 6, control device 4 outputs an electromagnetic wave oscillation signal of condition that generates non-equilibrium plasma before outputting the electromagnetic wave oscillation signal of condition that occur spark discharge. Electromagnetic wave power supply 2 thereby outputs the pulsed current of a predetermined duty ratio for a predetermined set period. An electromagnetic wave pulse is oscillated by the outputted pulse current, and then a discharge occurs from discharge electrode 5 via high-pressure circuit 6. This discharge allows an emission of electron from the gas molecule of the target space, and non-equilibrium plasma is thereby generated. In this non-equilibrium plasma, the particle temperature is maintained at low temperature because only the emitted electron temperature is high. Therefore, spark does not occur in this condition. However, the electric power required for the continuous spark discharge can be lowered because an energy state of gas molecule in the target object is high. As a result, the total amount of electric power required in the whole process cycle can be reduced in the plasma generating apparatus of the present invention. The erosion of discharge electrode 5 can be inhibited because the voltage necessary for spark discharge can be reduced.

The electromagnetic wave pulse of condition that generates such non-equilibrium plasma is preferably an electromagnetic wave pulse of condition that generates streamer discharge.

### Modification 2 of the First Embodiment

In the modification 2 of the first embodiment, a dielectric barrier discharge electrode (not illustrated) is provided near discharge electrode 5 of microwave plasma plug 50. This dielectric barrier discharge electrode is covered by insulator. Non-equilibrium plasma is generated in the target space by discharge from this dielectric barrier discharge electrode. The discharge from this dielectric barrier discharge electrode is controlled by control device 4 as well as microwave plasma plug 50.

Then, the spark discharge and the assistance discharge (mentioned above) are generated in discharge electrode 5. The installation position of the electromagnetic wave emission antenna of this modification, which is covered with the insulator, is not limited as long as it does not bar the advantage of the present invention; however, it is preferable that the antenna is allocated near discharge electrode 5 of microwave plasma plug 50 and such that a dielectric barrier discharge occur in the domain where spark discharge occur. FIG. 6 shows an example of the oscillation pattern of the electromagnetic waves of this modification.

Control device 4 first outputs an electromagnetic wave oscillation signal of conditions that generates non-equilibrium plasma using dielectric barrier discharge. Electromagnetic wave power supply 2 thus outputs the pulsed current of a predetermined duty ratio for a predetermined set period and promotes the discharge from the dielectric barrier discharge electrode. This discharge allows an emission of the electrons from the gas molecule in the target space, and non-equilibrium plasma is thereby generated. Control device 4 then outputs an electromagnetic wave oscillation signal of condition that occur spark discharge. Electromagnetic wave power supply 2 outputs the pulsed current of a predetermined duty ratio for a predetermined set period when such electromagnetic wave oscillation signal is received from control device 4. Electromagnetic wave oscillator 3 outputs the electromagnetic wave pulse of the predetermined duty ratio for the set period. The electromagnetic wave pulse outputted from electromagnetic wave oscillator 3 occur the spark discharge through the amplifying circuit. The electron is emitted from the gas molecule in the target space by this spark discharge and plasma is thereby generated.

Control device 4 then provides the energy to the plasma, and outputs an electromagnetic wave oscillation signal that occur an electric discharge of conditions that enlarges/maintains this plasma. Electromagnetic wave power supply 2 outputs the pulsed current of predetermined duty ratio for a predetermined set period when such an electromagnetic wave oscillation signal is received from control device 4. Electromagnetic wave oscillator 3 outputs the electromagnetic wave pulse of the predetermined duty ratio for the set period. The microwave (assistant microwave) outputted from electromagnetic wave oscillator 3 is discharged from discharge electrode 5 via the amplifying circuit to provide energy to the plasma generated by spark discharge and allows an enlargement and a maintenance of the plasma.

According to this modification, the energy state of the gas molecule in the target space can be made high by the dielectric barrier discharge. This can lower the electric power necessary for spark discharge. As a result, the total amount the required electric power in the whole process cycle can be reduced in the plasma generating apparatus of the present invention. The erosion of discharge electrode 5 can be inhibited also because the voltage used in the spark discharge can be reduced.

### Second Embodiment

### Internal Combustion Engine

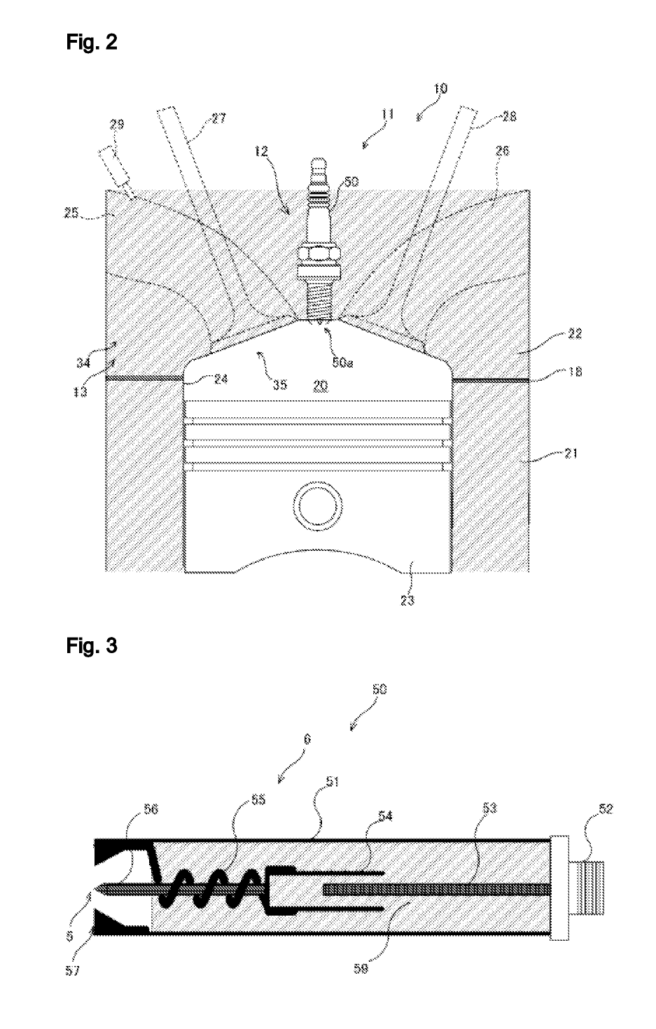

The second embodiment relates to internal combustion engine 10 that equips plasma generating apparatus 12 of the present invention. Plasma generating apparatus 12 generates the microwave plasma in combustion chamber 20 as the target space. Internal combustion engine 10 is a direct injection type gasoline engine as shown in FIG. 2. Internal combustion engine 10 has internal combustion engine body 11 and plasma generating apparatus 12.

Internal combustion engine body 11 is has cylinder block 21, cylinder head 22 and piston 23. Multiple cylinders with a circular cross section are formed in cylinder block 21. Piston 23 is formed in each cylinder 24 so as to reciprocate freely. Piston 23 is connected with the crankshaft via connecting rod (not illustrated). The crankshaft is supported by cylinder block 21 so as to rotate freely. When piston 23 in each cylinder 24 reciprocates in the axial direction of cylinder 24, the connecting rod converts a reciprocation movement of piston 23 into a rotational movement of the crankshaft.

Cylinder head 22 is places on located on cylinder block 21 so as to sandwich a gasket 18. Cylinder head 22 defines combustion chamber 20 together with cylinder 24 and piston 23.

Microwave plasma plug 50 is formed on cylinder head 22 for each cylinder 24. Tip portion 50a of the microwave plasma plug 50 functions as a discharge electrode. In this embodiment, microwave plasma plug 50 constitutes a portion of plasma generating apparatus 12. Microwave plasma plug 50 has a same geometry with the spark plug of the conventional automobile engine, and installs electromagnetic wave oscillator 3 and discharge electrode 5 inside.

Inlet port 25 and exhaust port 26 are formed in cylinder head 22 for each cylinder 24. Air intake valve 27 is provided in inlet port 25 for opening and closing the inlet port 25. On the contrary, exhaust valve 28 is provided in exhaust port 26 for opening and closing the exhaust port 26.

A single injector 29 is formed for each cylinder 24 in cylinder head 22. Injector 29 is projected toward combustion chamber 20 between the openings of two inlet ports 25. Injector 29 injects fuel from multiple nozzles in the mutually different direction. Injector 29 injects fuel toward the top surface of piston 23.

—Operation of the Internal Combustion Engine—

The plasma generating operation in the internal combustion engine of this embodiment is discussed. In the internal combustion engine of this embodiment, the plasma is generated by a discharge from tip portion 50a of microwave plasma plug 50 which functions as a discharge electrode.

Control device 4 first outputs the electromagnetic wave oscillation signal of conditions that occurs spark discharge. Electromagnetic wave power supply 2 outputs the pulsed current of predetermined duty ratio for a predetermined set period when such an electromagnetic wave oscillation signal is received from control device 4. Electromagnetic wave oscillator 3 outputs the electromagnetic wave pulse of a predetermined duty ratio for a set period. The electromagnetic wave pulse outputted from electromagnetic wave oscillator 3 becomes high voltage by amplifying circuit 6 inside microwave plasma plug 50, and causes spark discharge near the tip 50a of microwave plasma plug 50. Electrons are emitted from the fuel gas molecule in reaction room 20 by this spark discharge and plasma is generated.

Then, control device 4 provides energy to the plasma and outputs the electromagnetic wave oscillation signal of condition that enlarges and maintains this plasma. Electromagnetic wave power supply 2 outputs the pulsed current of a predetermined duty ratio for a predetermined set period when such an electromagnetic wave oscillation signal is received from control device 4. Electromagnetic wave oscillator 3 outputs the electromagnetic wave pulse of the predetermined duty ratio for the set period. The electromagnetic wave pulse outputted from electromagnetic wave oscillator 3 becomes high voltage via amplifying circuit 6, generates discharge near tip portion 50a of microwave plasma plug 50, provides energy to the plasma generated by spark discharge, and can thereby enlarges and maintains the plasma.

Similarly to the first embodiment, the pattern described in FIG. 5 can be used as an example of predetermined oscillation pattern in the internal combustion engine of this embodiment, which includes an electromagnetic wave pulse of condition that cause spark discharge, and an electromagnetic wave pulse of condition that enlarges and maintains the generated plasma. That is, the electromagnetic wave pulse of a certain electric power or more is required to cause spark discharge in reaction room 20 and to generate plasma. The electromagnetic wave pulse can be a single pulse, but can be multiple pulse of predetermined duty ratio, a predetermined set period as necessity. Then, the electromagnetic wave pulse of predetermined duty ratio is then oscillated for a predetermined set period to maintain and enlarge the generated plasma. Low electric power is required for enlarging and maintaining this plasma compared with the electricity needed to cause spark discharge.

### Advantage of the Second Embodiment

In the internal combustion engine of this second embodiment, the plasma generating apparatus that is similar to the first embodiment is utilized. Therefore, multiple power supplies are not necessary as in the internal combustion engine that equips a conventional plasma generating apparatus having a spark plug using the high voltage and a microwave radiation antenna. Further, complicated transmission lines are not necessary. Electromagnetic wave oscillator 3 and discharge electrode 5 can be installed inside microwave plasma plug 50 having the same geometry with the spark plug of the conventional automobile engine. Therefore, the structure of the engine itself does not have to be modified when the plasma generating apparatus of this embodiment is used for an automobile engine.

### Modification 1 of the Second Embodiment

Modification 1 of the second embodiment equips the similar plasma generating apparatus as the modification 1 of the first embodiment. Since the detail of such plasma generating apparatus was already detailed in the modification 1 of the first embodiment, the explanation is omitted here. The total amount of the required electric power can be reduced by having such plasma generating apparatus according to the internal combustion engine of this modification.

### Modification 2 of the Second Embodiment

Modification 2 of the second embodiment equips the similar plasma generating apparatus as the modification 2 of the first embodiment. Since the detail of such plasma generating apparatus was already detailed in the modification 2 of the first embodiment, the explanation is omitted here. Installation position of the dielectric barrier discharge electrode is not limited as long as it does not bar the advantage of the present invention; however, it is preferable that the electrode is allocated near discharge electrode 5 of microwave plasma plug 50 and such that the dielectric barrier discharge occur in the domain where spark discharge occur. The total amount of the required electric power can be reduced by having such plasma generating apparatus according to the internal combustion engine of this modification.

### Third Embodiment

### Exhaust Gas Decomposition Apparatus

The plasma generating apparatus of the present invention can be used as an exhaust gas decomposition apparatus. This exhaust gas decomposition apparatus equips an electromagnetic wave power supply, an electromagnetic wave oscillator, a control device, a microwave plasma plug containing an amplifying circuit and a discharge electrode, and a microwave resonant chamber (cavity) that cause resonation in the predetermined electromagnetic wave frequency. The plasma generating apparatus of the present invention can generate effective plasma solely by electromagnetic wave and a system such as a complicated transmission line are not necessary. Further, the consuming electric power can be reduced.

The exhaust gas decomposition apparatus of this embodiment allows an efficient generation of plasma in the microwave resonant chamber (cavity) because the harmful wastes, chemical substance, suspended particulate matter and soot are chemically oxidized and reacted to be detoxicated using the plasma product such as OH radical or ozone (O3).

### Fourth Embodiment

### Ozone Generation, Sterilization, Disinfection Apparatus, and Deodorization Apparatus

The plasma generating apparatus of the present invention is preferably used as the ozone generation, sterilization, disinfection apparatus, and deodorization apparatus. The plasma generating apparatus of the present invention converts efficiently a high pressure steam that contains moisture to a large amount of OH radical and O3. The exhaust gas is thereby decomposed into harmless gas by strong oxidization power of the large amount of OH radical and O3. Further, the large amount of O3 can be generated for ozone layer restoration of the stratosphere that is destroyed by chlorofluocarbon. The plasma generating apparatus of the present invention improves generation and enlargement efficiencies of plasma against the consuming electric power. An apparatus employing such plasma generating apparatus can thereby generate, sterilize, disinfect, and deodorize the ozone much efficiently.

### INDUSTRIAL APPLICABILITY

As discussed above, the plasma generating apparatus of the present invention requires only a single power supply and does not require complicated transmission lines because the plasma can be generated, enlarged, maintained solely by electromagnetic waves. Further, a predetermined oscillation pattern containing an electromagnetic wave pulse of condition that cause spark discharge, and an electromagnetic wave pulse of condition that enlarges and maintains the generated plasma is used. This allows an efficient generation, enlargement, and maintenance of plasma solely by electromagnetic wave and can reduce the total amount of power consumption. Therefore, the plasma generating apparatus of the present invention can be used preferably for internal combustion engines such as an automobile engine, or exhaust gas decomposition apparatuses.

1. A plasma generating apparatus including an electromagnetic wave oscillator that oscillates electromagnetic wave and a control device that controls the electromagnetic wave oscillator, comprising:
an amplifying circuit that cause resonation of an electromagnetic wave oscillated by an electromagnetic wave oscillator and generates high voltage; and
a discharge electrode that discharges high voltage generated by the amplifying circuit.

2. The plasma generating apparatus as claimed in claim 1, wherein the amplifying circuit includes a resonating circuit that is capacity coupled with the electromagnetic wave oscillator.

3. The plasma generating apparatus as claimed in claim 2, wherein the amplifying circuit includes a plurality of resonating circuits.

4. The plasma generating apparatus as claimed in claim 2, wherein at least one of the resonating circuits is a parallel resonance circuit.

5. The plasma generating apparatus as claimed in claim 4, further comprising a serial resonating circuit in the discharge electrode side of the parallel resonance circuit.

6. The plasma generating apparatus as claimed in claim 1, wherein
the control device controls the electromagnetic wave oscillator such that the oscillator oscillates according to an oscillation pattern that includes an electromagnetic wave pulse of condition that occur a spark discharge in the discharge electrode and an electromagnetic wave pulse that enlarges and maintains the plasma generated by the spark discharge.

7. The plasma generating apparatus as claimed in claim 6, wherein
the oscillation pattern further includes an electromagnetic wave pulse of condition that generates a non-equilibrium plasma prior to an electromagnetic wave pulse of condition that occur the spark discharge.

8. The plasma generating apparatus as claimed in claim 7, wherein
the electromagnetic wave pulse of condition that generates non-equilibrium plasma is an electromagnetic wave pulse of condition that generates a streamer discharge.

9. An internal combustion engine comprising:
a plasma generating apparatus as claimed in claim 1; and
an internal combustion engine body forming a combustion chamber therein.
